(19) United States
(12) Patent Application Publication
(10) Pub. No.: US 2008/0164703 A1
(43) Pub. Date: Jul. 10, 2008

(54) Device for Assisting in Opening/Closing an Openable Unit

(75) Inventors: Anthony Aubry, Creteil Cedex (FR); Tamim Belhaj, Creteil Cedex (FR)

Correspondence Address: OSHA LIANG L.L.P., 1221 MCKINNEY STREET, SUITE 2800, HOUSTON, TX, 77010, US

(73) Assignee: Valeo Securite Habitacle, Creteil Cedex (FR)

(21) Appl. No.: 11/629,599

(22) PCT Filed: Jun. 6, 2005
(86) PCT No.: PCT/EP05/52585

§ 371 Date: Mar. 19, 2008

(30) Foreign Application Priority Data
Jun. 14, 2004 (FR) 0406406

(51) Int. Cl. E05B 65/12; E05C 3/16

(52) U.S. Cl. 292/201

(57) ABSTRACT

The invention relates to a device for power-assisted opening/closing of an openable panel in a motor vehicle, comprising: a latch (9) for disengaging/engaging a striker; a pawl (10) able to lock the latch (9) in at least one locked position and release said latch (9); a first kinematic chain (3) for power-assisted closing, of which one end is connected to a motor (1) and the other to said latch (9); and a second kinematic chain (4) for power-assisted opening, of which one end is connected to said motor (1) and the other to said pawl (10); which device is characterized in that said motor (1) comprises a through shaft (2), of which one end forms a driving connection with said first kinematic chain (3) and the other a driving connection with the second kinematic chain (4).

The invention relates to a device for assistance in opening/closing an openable unit. It applies particularly to the locks of openable panels in the automotive industry, such as side doors, comprising one or two closing catches for assisting with closure during compression of the panel sealing strip and with opening for enhanced user comfort.

Systems for power-assisted opening and closing comprising two motors or one motor with an output that turns in both directions are currently available on the market.

An example from the prior art is patent application WO 0049252.

In patent application WO 0049252, the device comprises: a latch for disengaging/engaging a striker; a pawl able to lock the latch in at least one locked position and release said latch; a link able to act on the latch during power-assisted closing; a first kinematic chain for power-assisted closing, of which one end is connected to a motor and the other to said link; and a second kinematic chain for power-assisted opening, of which one end is connected to said motor and the other to said pawl.

In that system, therefore, one motor works in both directions of rotation with an electromagnetic clutch to control the opening phase or closing phase. During the closing phase a motor operates a pinion and allows the latch to close, first to the first catch and then to the second catch. During the opening phase the motor operates the pinion in the other direction and allows the latch to be released by acting on the pawl. The electromagnetic clutch with the spring allows the part to return to its initial position when operated in the opening or closing direction and prevents residual stresses occurring in the closing or opening chain.

There are problems with this type of system. It always requires an electronic means of controlling the motor to rotate it in the two directions, namely opening and closing, and this makes the kinematic chain complicated and therefore renders it less reliable and more expensive. In addition, with regard to the same problems, this type of system also requires the use of an electromagnetic clutch and a system for controlling this clutch. Lastly, the electromagnetic clutch requires the presence of two switches, one in contact with the latch and the other in contact with the pawl, in order to determine the states of these two components. These switches represent a not inconsiderable cost and as far as electronic devices go are comparatively unreliable, or fragile, after lengthy use.

It is an object of the present invention to solve the problems of the devices of the prior art by providing a simpler system, in the sense of one that requires fewer control or actuating elements, is mechanically more reliable, and is less expensive to produce. The present invention also provides for this purpose two particular embodiments, each with its own advantages.

Thus, the subject of the invention is a device for power-assisted opening/closing of an openable panel in a motor vehicle, comprising: a latch for disengaging/engaging a striker; a pawl able to lock the latch in at least one locked position and release said latch; a first kinematic chain for power-assisted closing, of which one end is connected to a motor and the other to said means of actuation; and a second kinematic chain for power-assisted opening, of which one end is connected to said motor and the other to said pawl; which device is characterized in that said motor comprises a through shaft, of which one end forms a driving connection with said first kinematic chain and the other a driving connection with the second kinematic chain.

The first kinematic chain comprises, at its end in contact with the latch, a means of unilateral actuation by contact able to act on the latch during power-assisted closing.

A means of unilateral actuation by contact consists of a component able to push, or propel, the latch during power-assisted closing, in other words when the first kinematic chain is active, and to withdraw, or disengage itself, from its contact with the latch and from its path of rotation during an action to open the openable panel, so that the latch can turn without hindrance.

Thus, by using one motor with a through shaft in accordance with the device of the invention, it is now possible to transmit torque from both sides of the motor.

One of the advantages of the device of the invention is that it uses only one motor to give power-assisted closing or opening.

In one embodiment of the invention, the first kinematic chain will comprise a freewheel, which freewheel transmits the drive when rotating in a first direction so that said kinematic chain acts, via the means of unilateral actuation by contact, on the latch for power-assisted closing, said freewheel being inactive when rotating in the opposite direction to said first direction.

In this embodiment, the pinions or wheels making up the first and second kinematic chains are able to turn in both directions of rotation. The advantage of the first embodiment, with the freewheel, lies in the simplicity and mechanical reliability of this component, which needs no dedicated means of control.

In a second embodiment of the invention, the freewheel is replaced by a clutch. Thus, the first kinematic chain will comprise a clutch, such as an electromagnetic clutch, able to activate/deactivate the action of said first kinematic chain on said means of actuation. In this solution the clutch is coupled to a return spring to return said clutch to the active position in such a way as to reactivate the said first kinematic chain so that the latter is able to act on said means of actuation.

In the second embodiment, the pinions or wheels of the first and second kinematic chains can only turn in one direction of rotation. The use of a clutch and a return spring ensures that there is no permanent stress on the first kinematic chain during closing. Another advantage of this embodiment of the invention is that it requires electronic control of the motor in only one direction, since in this embodiment the through shaft only turns in one direction.

The invention is described below in more detail, with the help of figures showing only preferred embodiments of the invention.

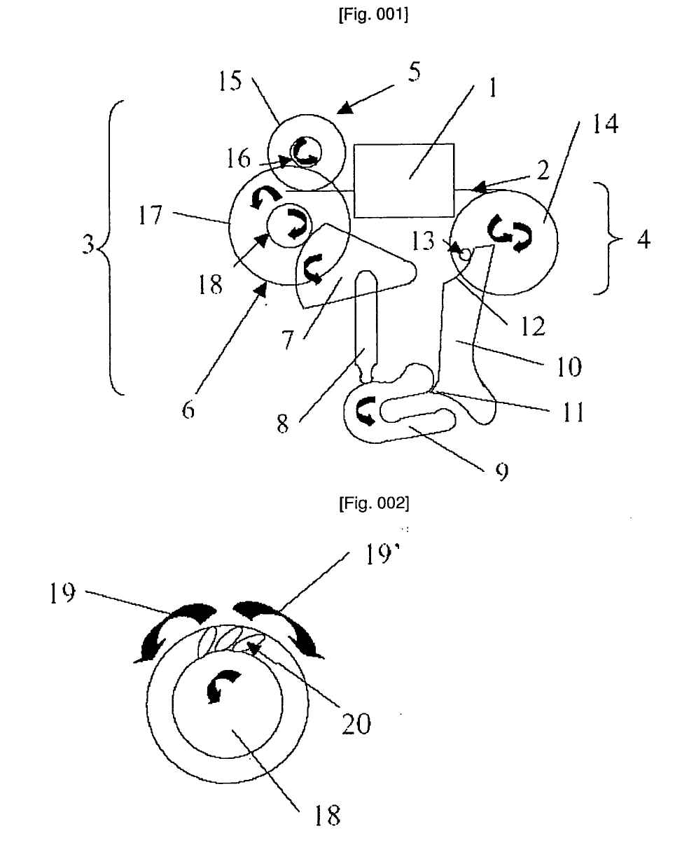

FIG. 1 is a schematic view illustrating the operation of a device in accordance with the invention in the first embodiment.

FIG. 2 is a schematic view of the cam freewheel used in the first kinematic chain of the first embodiment of the invention.

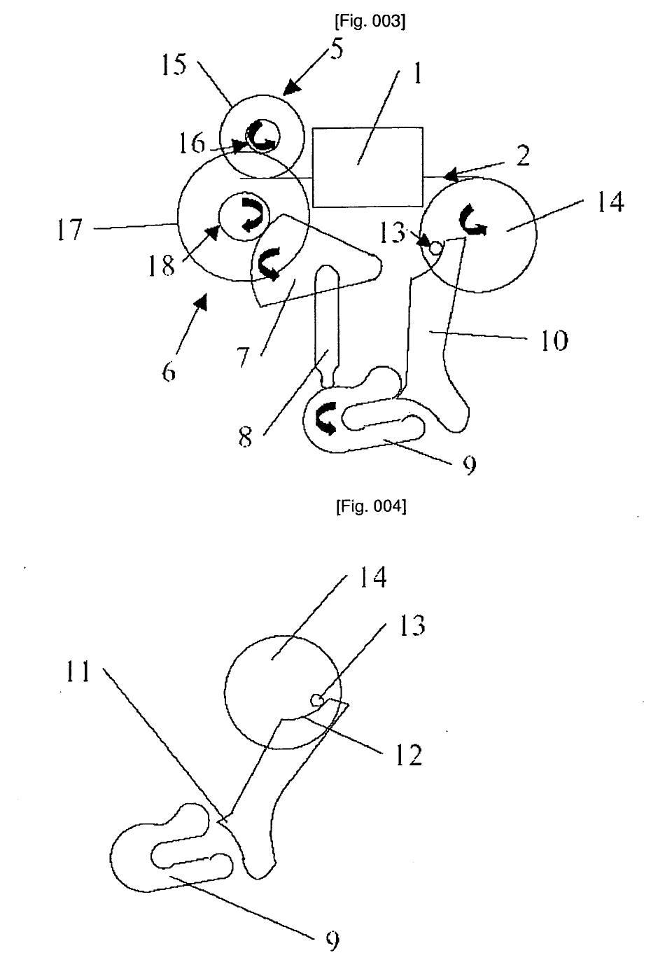

FIG. 3 is a schematic view illustrating the operation of a device in accordance with the invention in a second embodiment.

FIG. 4 is a schematic view of the latch, pawl and second kinematic chain in the “just open” position, in the second embodiment of the invention.

Hereinafter, the example selected to illustrate the invention comprises individual components fulfilling the function defined in the claims. Thus, the means of unilateral actuation by contact consists here of a link 8. However, it will be seen that this component 8 could also be a gear wheel with a bearing surface able to act on the latch, exactly like that described in patent application WO 0049252.

The first and second embodiments of the power-assisted opening/closing device according to the invention, shown in FIGS. 1-2 and 3-4, respectively, both have the following components:
a single electric motor 1 with a through shaft 2 whose ends are situated on either side of the motor 1 so that the first 3 and second 4 kinematic chains are entirely situated on either side of the motor 1,
a first kinematic chain 3, designed for power-assisted closing, comprising two drive wheels 5 and 6, one 5 of which is caused to rotate by one end of the through shaft 2, and a sector gear 7 acting on a link 8,
a link 8, which when actuated by the first kinematic chain 3 pushes on a latch 9, which latter drives the openable panel in such a way as to help it to close; specifically, during power-assisted closing, the latch 9 hooks onto the striker (not shown in the accompanying figures), and pulls the openable panel towards the frame, irrespective of whether the striker is on the frame and the latch 9 on the openable panel, or vice versa,
a latch 9 in the shape of a U having two approximately parallel arms forming a housing for a striker (not shown in the accompanying figures),
a pawl 10 extending approximately along a linear axis, having at one end a projecting spur 11, or a flange, to lock the latch 9 in at least one locked position, and at the other end a generally curvilinear or circular contact surface 12 that contacts a crank pin 13 mounted on
the second kinematic chain 4 designed for power-assisted opening, which here comprises a single pinion 14 caused to rotate by the other end of the through shaft 2, said pinion 14 being provided with a crank pin 13 of for example cylindrical shape.

The electric motor 1 is housed in a housing or the like from which the two respective ends of the through shaft 2 project from opposite faces. The through shaft 2, which is of conventional design, extends linearly and its two ends project just sufficiently to cause rotation of the two kinematic chains 3 and 4.

The first kinematic chain 3, or kinematic chain for power-assisted closing, consists of a first drive wheel 5 comprising two wheels 15, 16 of different diameters. The larger of the two wheels 15 is in contact—that is, its peripheral surface is in contact—with one end of the through shaft 2 driving it, while the second wheel 16, whose diameter is smaller than that of the first wheel 15, is in contact with one wheel 17 of the second drive wheel 6 in order to drive it. The second drive wheel 6 includes a cam-type freewheel (not visible) situated between the wheel 17 and a second wheel 18 whose diameter is smaller than the wheel 17. The second wheel 18 is in contact with a sector gear 7 whose surface contacting the second wheel 18 forms a portion of a circle.

It is of course possible to replace the cam- or roller-type freewheel with a ramp-type freewheel or any other type of freewheel capable of permitting rotation, and communicating this rotation, in only one direction of rotation of the motor 1.

The first kinematic chain 3 comprises, at its end in contact with the link 8, the sector gear 7 which is able to act on the link 8. Thus, when the freewheel rotates, in its permitted direction of rotation, and drives the second wheel 18, which in turn drives the sector gear 7, the sector gear 7 also rotates and drives the link 8, or operating link. The link 8 here has a function of operating the latch 9 by contacting and pushing it, in such a way as to cause it to rotate, this last action being the final action of power assisted closing.

In the context of the first embodiment the freewheel is permitted to rotate in only one direction, which means that there is one active direction of rotation of the motor from the point of view of the freewheel and one inactive direction of rotation of the motor from the point of view of the freewheel.

Accordingly, during power-assisted opening, the motor 1 is activated and turns the through shaft 2, clockwise in the example chosen to illustrate the invention. This has the effect, in the second kinematic chain 4, of turning the pinion 14 and its crank pin 13. The crank pin 13, which is in contact with the basically curvilinear or circular end 12 of the pawl 10, drives the pawl 10, which releases the latch 9 and allows the openable panel—such as a door of a motor vehicle—to be opened. At the same time the first kinematic chain 3 is also driven by the action of the other end of the through shaft 2. The two drive wheels 5 and 6 are thus caused to rotate as explained earlier, but the freewheel forming a coupling between the two wheels 17 and 18 of the second drive wheel 6, cannot turn when the through shaft 2 is rotating clockwise, for power-assisted closing; in other words the freewheel is inactive, so that the wheel 18 does not turn and remains static. The sector gear 7 and the link 8 do not therefore move, and remain stationary or immobile.

During power-assisted closing, the motor 1 is activated and turns the through shaft 2 in the counterclockwise direction, which drives the first kinematic chain 3 as explained earlier, the freewheel now being active. In this way, the wheel 18 rotates in the direction indicated by the arrow and so drives the sector gear 7. Operated by the sector gear 7, the link 8 pushes on the latch 9 and drives the latch 9 which drives the openable panel and helps to close it. Regarding the second kinematic chain 4, the rotation of the pinion 14 simply returns the crank pin 13 to its initial position, in which the pawl 10 locks the latch 9.

After power-assisted closing, the link 8 remains in contact with the latch 9. The presence of the return spring of the link 8 performs its action when the panel is opened (the motor rotating in the other direction) and thus releases the contact of the link 8 from the latch 9 to allow opening.

For safety reasons, of course, one of the functions of a motor vehicle is to allow the openable panel to be opened at any moment, and in particular in the middle of power-assisted closing. This is the so-called “over-ride” function.

In the case of power-assisted closing with over-ride for the first embodiment, if, while the openable panel is being closed, a request to open it is made, the motor 1, rotating in the closing direction, stops and rotates in the other direction to open it. This action is controlled by the conventional means of electronic control of the motor 1, which are familiar to those skilled in the art.

As illustrated in FIG. 2, rotation of the through shaft 2 in the counterclockwise direction, or power-assisted closing, causing the wheel 17 to rotate in the direction indicated by the arrow 19, locks the rollers 20 and drives the wheel 18, whereas when the through shaft 2 is rotating in a clockwise (power-assisted opening) direction, in the direction of the arrow 19′, the wheel 17 slips on the rollers 20, and the wheel 18 is not driven.

In the case of the second embodiment, shown in FIGS. 3 and 4, the freewheel of the first embodiment has been replaced by an electromagnetic clutch (not shown in the accompanying figures) in the same place between the wheel 17 and the wheel 18 of the second drive wheel 6. In addition, in this embodiment there is only one direction of rotation of the through shaft 2 to control power-assisted opening and closing.

Thus, in the power-assisted opening phase, the motor 1 is activated and turns the through shaft 2 clockwise, causing the pinion 14 to turn and drive the attached crank pin 13 as far as the “just open” position shown in FIG. 4, where the pawl 10 releases the latch 9, and the basically curvilinear or circular surface 12 of the pawl 10 remains in contact with the crank pin 13. The pawl 10 therefore rises and releases the latch 9, which allows the openable panel—e.g. the door—to open. As in the first embodiment, the through shaft 2 of the motor 1 also drives the first kinematic chain 3. Here, however, the clutch disconnects the wheels 17 and 18 so that the sector gear 7 and link 8 do not move.

In the power-assisted closing phase, the motor 1 is activated and the through shaft 2 turns in the same direction as for power-assisted opening, in the clockwise direction, therefore, for example, but the clutch couples the wheels 17 and 18 so that the sector gear 7 drives the link 8 which acts on the latch 9, as explained before in the first embodiment. In this phase, the crank pin 13 and the pawl 10 are initially in the “just-open” position shown in FIG. 4 achieved after the power-assisted opening phase.

Thus, the clutch is controlled by a means (not shown in the accompanying figures) which determines the active/inactive state of the first kinematic chain 3 depending on whether a request to open or close the openable panel is given by the user. The active state of the first kinematic chain 3 corresponds to the sector gear 7 and the link 8 actually being driven, and the inactive state of the first kinematic chain corresponds to no drive being applied to these latter components 7 and 8, which therefore do not move.

As before, in the case of power-assisted closing with over-ride for this second embodiment, if, during closing, an opening request is made, the clutch is deactivated and disconnects the wheels 17 and 18, rendering the first kinematic chain 3 inactive. The motor 1 carries on turning and the opening of the panel is brought about via the crank pin 13.

1. A device for power-assisted opening/closing of an openable panel in a motor vehicle, comprising:
a latch for disengaging/engaging a striker;
a pawl able to lock the latch in at least one locked position and release said latch;
a first kinematic chain for power-assisted closing, of which one end is connected to a motor and the other to said latch;
and a second kinematic chain for power-assisted opening,
of which one end is connected to said motor and the other to said pawl;
which device is characterized in that said motor comprises a through shaft,
of which one end forms a driving connection with said first kinematic chain and
the other a driving connection with the second kinematic chain.

2. The device as claimed in claim 1, characterized in that the first kinematic chain comprises, at its end in contact with the latch, a means of unilateral actuation by contact able to act on the latch during power-assisted closing.

3. The device as claimed in claim 1, characterized in that the first and second kinematic chains are situated entirely on opposite sides of said motor.

4. The device as claimed in claim 2, characterized in that the abovementioned first kinematic chain comprises, at its end in contact with the means of unilateral actuation by contact, a sector gear able to act on said means.

5. The device as claimed in claim 1, characterized in that the second kinematic chain comprises a pinion provided with a crank pin.

6. The device as claimed in claim 2, characterized in that the abovementioned first kinematic chain comprises a freewheel, which freewheel transmits the drive when rotating in a first direction so that said kinematic chain acts, via the means of unilateral actuation by contact, on the latch for power-assisted closing, said freewheel being inactive when rotating in the opposite direction to said first direction.

7. The device as claimed in claim 2, characterized in that the first kinematic chain comprises a clutch, such as an electromagnetic clutch, able to activate/deactivate the action of said first kinematic chain on the means of unilateral actuation by contact.

8. The device as claimed in claim 7, characterized in that the clutch is coupled to a return spring to return said clutch to the active position in such a way as to reactivate the abovementioned first kinematic chain so that the latter is able to act on the means of unilateral actuation by contact.

9. The device as claimed in claim 7, characterized in that the clutch is controlled by a means of controlling the inactive/active state of the first kinematic chain depending on whether the user requests to open/close, respectively, the openable panel.

10. The device as claimed in claim 2, characterized in that the means of unilateral actuation by contact is a link.

11. The device as claimed in claim 8, characterized in that the clutch is controlled by a means of controlling the inactive/active state of the first kinematic chain depending on whether the user requests to open/close, respectively, the openable panel.
